(19) United States
(12) Patent Application Publication
(10) Pub. No.: US 2012/0229854 A1
(43) Pub. Date: Sep. 13, 2012

(54) PRINT DATA PROCESSING METHOD, PRINT DRIVER, AND CONTROL DEVICE

(75) Inventors: Hidetoshi MAESHIMA, Shiojiri-shi (JP); Shigeo IKEDA, Matsumoto-shi (JP)

(73) Assignee: SEIKO EPSON CORPORATION, Shinjuku-ku (JP)

(21) Appl. No.: 13/417,123

(22) Filed: Mar. 9, 2012

(30) Foreign Application Priority Data
Mar. 11, 2011 (JP) 2011-053792

(51) Int. Cl. G06F 3/12

(52) U.S. Cl. 358/1.15

(57) ABSTRACT

A media processing device executes a printing process that prints data created by a desired software program on the label side of a medium, and a write process that writes data to the medium, in a continuous operation. A production command step commands executing a media production process. An image data acquisition step acquires image data produced by a desirable application when triggered by the production command. A print data generating step generates print data from the image data. A data acquisition step acquires data used in the write process when triggered by the production command. A data output step links and outputs the print data and the write data to the media processing device.

### BACKGROUND

1. Technical Field

The present invention relates to a print data processing method, print driver, and control device for controlling a media processing device that performs a write process to write on the recording surface of a medium and a printing process to print on the label side of the medium.

The present application claims the priority of Japan Patent No. 2011-053792 filed on Mar. 11, 2011, all contents of which are herein incorporated by reference.

2. Related Art

Devices that have a dedicated application for a media processing device installed in a control device and produce media (referred to below as a media processing system) are known from the literature. See, for example, the EPSON PP100 User Guide (http://dl.epson.jp/support/manual/data/discproducer/pp100/4112999_{—}02.PDF, pp. 27-80). This media processing device edits the write data and print data for the label side using the dedicated application, and then executes the write process and printing process in a continuous operation when triggered by a publish command from the control device.

The images printed on the label side of media produced for commercial purposes also function as advertising and describe the content recorded on the media, and high image quality (including resolution and color control) on the label side is desirable. In this case an image production program that can generate higher quality image data than the above dedicated application could conceivably be used to produce the image data for printing on the label side. However, the media processing system described above cannot execute the write process and printing process in a single continuous operation when print data output from a program other than the dedicated application is printed on the label side. More specifically, the printing process is executed when the control device issues a print command, and the write process is executed when the control device issues a write command. As a result, the user must perform an operation to start the process (such as pressing a button and loading/unloading the media) each the processes execute, and publishing a disc is therefore time-consuming.

### SUMMARY

A print data processing method, print driver, and control device according to the invention enable causing a media processing device to perform a printing process to print data created by a general purpose software program that is incompatible with the media processing device on the label side of media, and a write process that writes content data, in a single continuous operation.

A first aspect of the invention is a print data processing method for controlling a media processing device that performs a write process to write data to the recording surface of media based on write data, and a printing process to print on the label side of the media based on print data, including: a production command step that issues a production command for executing a media production process; an image data acquisition step that acquires image data produced by a desirable application for printing on the label side when triggered by the production command; a print data generating step that generates print data based on the image data; a data acquisition step that acquires data used in the write process when triggered by the production command; and a data output step that links and outputs the print data and the write data to the media processing device.

Another aspect of the invention is a print driver for controlling a media processing device that performs a write process to write data to the recording surface of media based on write data, and a printing process to print on the label side of the media based on print data, including: an image data acquisition unit that acquires image data produced by a desirable application for printing on the label side; a print data generating unit that generates print data based on the image data; a data acquisition unit that acquires data used in the write process; and an output control unit that links and outputs the print data and the write data to the media processing device.

The print driver in these aspects of the invention has a function that selects the write data and outputs the write data linked to the print data. Because the print driver issues the print command, the printing process and write process can be executed on the media processing device in a single continuous operation even when data created by a common software application is printed on the label side of the media.

Preferably, the data acquisition step acquires one or more content data objects; an image file generating step generates an image file combining the one or more acquired content data objects according to a specific format; and the data output step outputs the generated image file as the write data.

In this aspect of the invention the print driver can generate an image file from one or more content data objects, and a separate program for previously generating the image file is not required.

Another aspect of the invention is a control device having the foregoing print driver, and is used connected to a media processing device.

Because the print driver issues print commands in this configuration, the control device can cause the media processing device to execute the printing process and write process as a continuous operation.

A media processing system according to another aspect of the invention includes the foregoing control device and a media processing device.

This aspect of the invention enables causing the media processing device to execute the printing process and write process as a continuous operation, even when printing data created by a general software application that is not compatible with the media processing device on the label side of media, because the print driver issues the print commands.

Another aspect of the invention is a program that causes a computer to execute the steps of the print driver control method described above.

This aspect of the invention enables providing a program causing a media processing device to execute a printing process and write process as a continuous operation because the print driver issues the print commands.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the functional configuration of the media processing system according to a preferred embodiment of the invention.

FIG. 2 shows an example of a print settings window.

FIG. 3 is a flow chart of the media production process.

### DESCRIPTION OF EMBODIMENTS

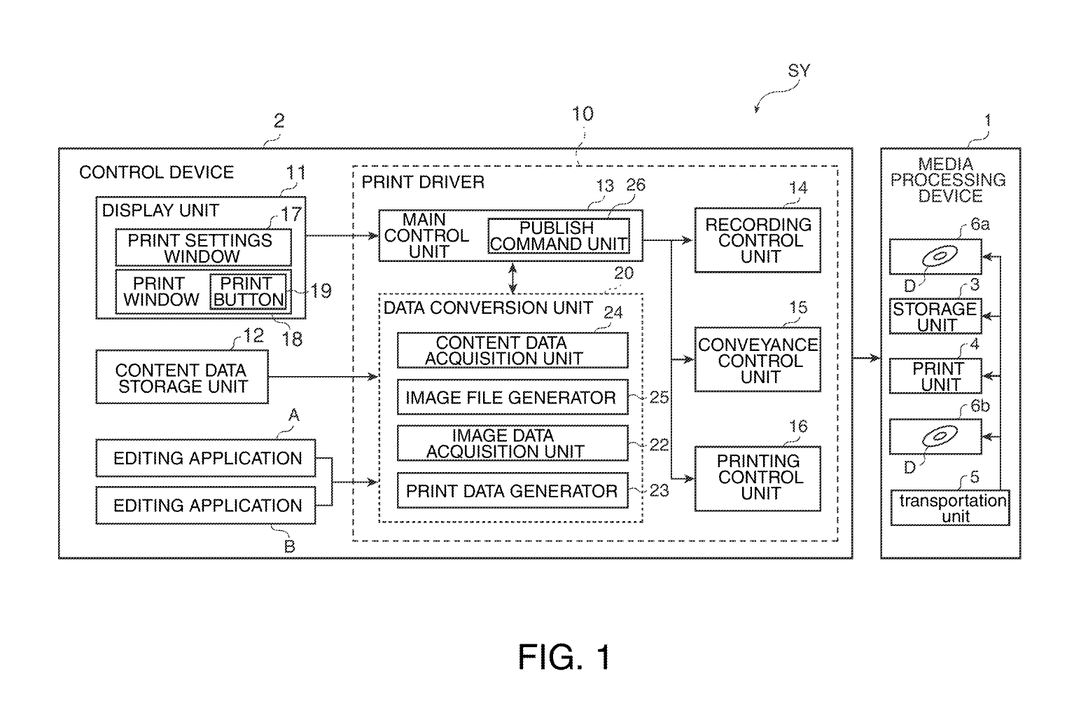

A print driver, control device, print data processing method, and program according to a preferred embodiment of the present invention are described below with reference to the accompanying figures. FIG. 1 is a block diagram showing the functional configuration of the media processing system SY according to this embodiment of the invention. As shown in the figure, the media processing system SY includes a media processing device 1 that applies a write process and a label side printing process to a disc D, which is an optical recording medium (media). The control device is rendered by a personal computer or server, for example.

The media processing device 1 has a recording unit 3 that performs a write process on a recording surface of the disc D, a print unit 4 that performs a printing process on the label side of the disc D, a transportation unit 5 that transports the disc D, and a storage unit 6 that stores discs D.

The transportation unit 5 includes an arm (not shown) that holds and moves the disc D horizontally (on the x-axis), a guide (not shown) that moves the arm vertically (on the y-axis), and a drive unit (not shown) that can slide axially along the guide and rotates on the axis of the guide, and transports the disc D to different parts of the media processing device 1 in conjunction with driving the drive unit.

The storage unit 6 includes an unprocessed disc storage unit 6a that stores discs D to which the write process and printing process have not been applied, and a processed disc storage unit 6b that stores the discs D for which the write process and printing process are finished. Each storage unit has a cylindrical storage case that can store several ten discs D in a stack (not shown).

Operation of the media production process of the media processing device 1 is described briefly next.

When the user has set one or more blank discs D to which the write process and printing process have not been applied in the unprocessed disc storage unit 6a, the transportation unit 5 first conveys a disc D from the unprocessed disc storage unit 6a to the recording unit 3 based on a command from the control device 2 described below. The recording unit 3 then performs the write process on the recording surface of the loaded disc D. When the write process of the recording unit 3 ends, the transportation unit 5 carries the disc D from the recording unit 3 to the print unit 4. The print unit 4 then performs the printing process on the label side of the loaded disc D. Note that the print unit 4 has an inkjet head and prints on the label side using an inkjet printing method. When the print unit 4 finishes the printing process, the transportation unit 5 carries the disc D from the print unit 4 to the processed disc storage unit 6b. The user can then remove the finished disc D from the processed disc storage unit 6b.

The configuration of the control device 2 that controls the foregoing media processing device 1 is described next. The control device 2 has a display unit 11, content data storage unit 12, editing application A, editing application B, and print driver 10.

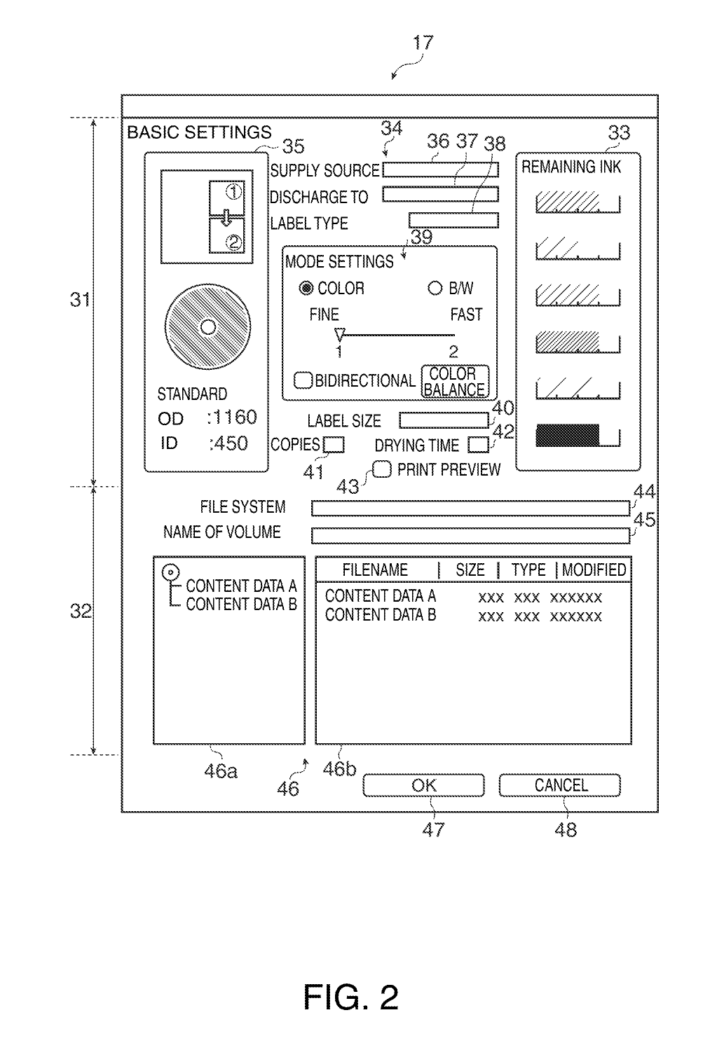

The display unit 11 displays the recording content to be recorded on the disc D, and the print content to be printed on the label side. The display unit 11 also displays a print window 18 for printing image data edited using an editing application A or B described below, and a print settings window 17 for configuring print settings (see FIG. 2), and provides an input function for configuring print settings and issuing print commands. Note that the print window 18 has a print button 19 (publish command button, print command button) for executing the printing process and write process, and a settings button (not shown in the figure) for displaying the print settings window 17.

The content data storage unit 12 stores one or more content data objects for writing to the recording surface of the disc D.

The editing applications A, B are applications for editing image data for printing on the label side of the disc D. These editing applications A, B are not applications written specifically for the media processing device, and could be any desired common image editing program. This embodiment is also described with two applications installed on the control device 2, but the number of installed applications is not so limited.

The print driver 10 includes a main control unit 13, data conversion unit 20, recording control unit 14, conveyance control unit 15, and printing control unit 16.

The main control unit 13 schedules the sequence of processes used to produce a disc D, and controls the operating procedures of the different parts of the media processing device 1. The main control unit 13 has a publish command unit 26 for asserting a disc publishing command, and instructs the recording control unit 14, conveyance control unit 15, and printing control unit 16 to execute the publishing process. At this time the main control unit 13 links the data for the write process and the data printing that was converted by the data conversion unit 20 described below, and instructs the recording control unit 14 and conveyance control unit 15 to output the data to the media processing device 1. As a result, the recording unit 3, transportation unit 5, and print unit 4 can execute the processes efficiently without interfering with each other.

The data conversion unit 20 converts the data stored in the content data storage unit 12, and the data edited by the editing applications A, B, to data formats compatible with the recording unit 3 and print unit 4 devices. The data conversion unit 20 includes a image data acquisition unit 22 that acquires image data from the editing applications A, B; a print data generator 23 that generates print data from the acquired image data; a content data acquisition unit 24 (data acquisition unit) that acquires one or more content data objects specified by the content data storage unit 12; and an image file generator 25 that generates an image file for performing the write process from the acquired content data.

The print data generator 23 generates a PRN file (print data) composed of the data to be printed on the label side of the disc D in a file format based on the image data output from the editing applications A, B.

The content data acquisition unit 24 acquires the content data selected by the user using the print settings window 17 as an interface from the content data storage unit 12. The content data includes the content of the data to be written to the recording surface of the disc D, and data describing the data structure and attributes. The content data points to files created by a word processor or spreadsheet application, for example.

The image file generator 25 combines the one or more selected content data objects and generates an image file according to the specified format.

The recording control unit 14 outputs the image file to the recording unit 3 of the media processing device 1 and controls operation of the recording unit 3 as scheduled by the main control unit 13. The conveyance control unit 15 controls operation of the transportation unit 5 of the media processing device 1 as scheduled by the main control unit 13. The printing control unit 16 outputs print data to the print unit 4 of the media processing device 1 and controls operation of the print unit 4 as scheduled by the main control unit 13.

Note that an output control unit is embodied by the main control unit 13, recording control unit 14, conveyance control unit 15, and printing control unit 16.

The print settings window 17 presented by the print driver 10 is described next with reference to FIG. 2. The print settings window 17 has a print settings display area 31 at the top for displaying specific print settings, and a content data selection display area 32 at the bottom for selecting the content data.

The print settings display area 31 includes a remaining ink display area 33 that displays the remaining ink level of the print unit 4 in the media processing device 1; a configurable settings display area 34 that displays the configurable settings; and a setup display area 35 that graphically displays the location of the storage unit 6 holding the discs D to use, and the area to be printed on the label side. The remaining ink display area 33 displays the remaining ink level for each color of ink (C, M, Y, K, LC, LM).

The configurable settings display area 34 includes a disc source selector 36 for selecting the storage unit 6 in which the blank discs D are stored (unprocessed disc storage unit 6a); disc discharge selector 37 for selecting the storage unit 6 into which the processed discs D are discharged (processed disc storage unit 6b); a label type selector 38 for selecting the type of label to be printed on the discs; a print mode selector 39 for setting the print mode; a label size selector 40 for selecting the label size; a disc number selector 41 for inputting the number of discs D to print; an ink drying time selector 42 for setting the time reserved for drying the ink in the print unit 4 after the printing process is completed; and a print preview selector 43 for setting whether or not to display a print preview before printing.

The print mode selector 39 includes objects for selecting color printing or monochrome printing, setting the print quality from FINE prioritizing print quality to FAST prioritizing printing speed, selecting whether or not to print bidirectionally, and setting the color balance used for printing. Note that bidirectional printing refers to printing in both directions as the printhead of the print unit 4 moves reciprocally through the printing area. When bidirectional printing is not selected, the print unit 4 prints only in one direction.

The content data selection display area 32 includes a file system selector 44 for selecting the file system for generating an image file from the selected content data; a volume label input box 45 for inputting a name for the data written to the disc D; and a content data selection area 46 for selecting the content data.

The user uses the file system selector 44 to select the file system according to the generated image file, and inputs the desired name of the volume in the volume label input box 45.

The content data selection area 46 has a data tree display area 46a and data list display area 46b. The user selects the content data to be written by dragging and dropping the desired content data displayed in a separate window into the data tree display area 46a or data list display area 46b. The content data that was dragged and dropped is displayed in a data list in the data list display area 46b and a data tree in the data tree display area 46a. This enables the user to easily check the content data that will be written.

The print settings window 17 also has an OK button 47 for issuing a print command, and a cancel button 48 for cancelling printing, on the right below the content data selection display area 32.

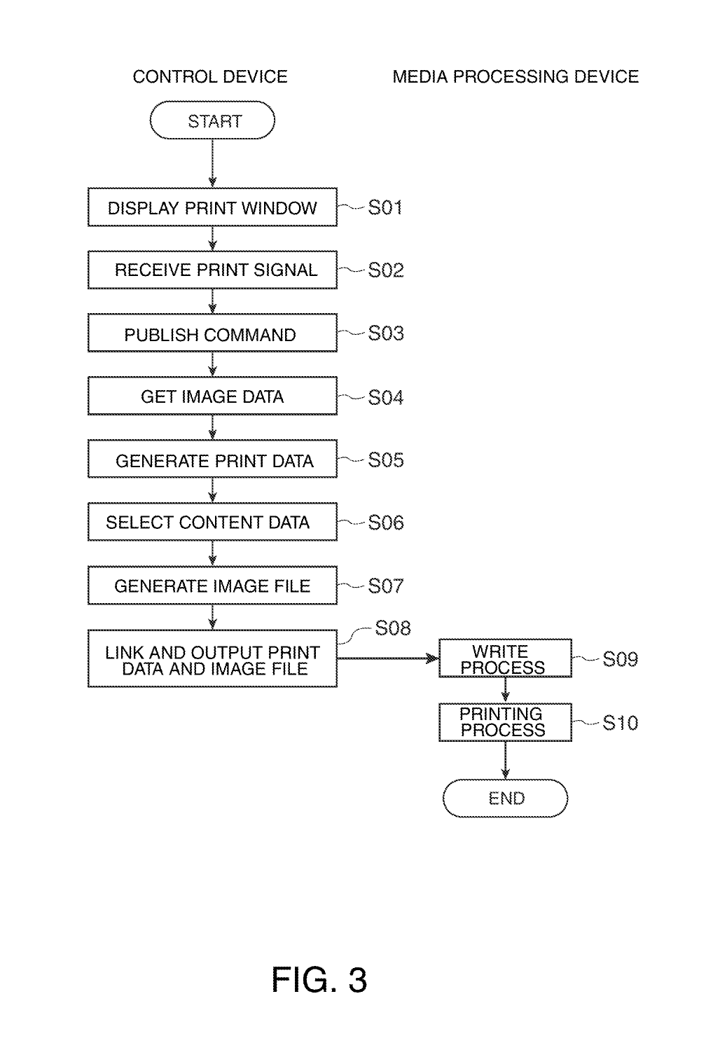

The media production process (print data processing method) of the media processing system SY according to this embodiment of the invention is described next with reference to the flow chart in FIG. 3.

First, the control device 2 displays the print window 18 containing the image data selected by the user (S01). In this example the user has already completed the settings made in the print settings window 17 at this time. When a signal denoting that the print button 19 of the print window 18 was pressed (S02), the control device 2 issues a publish command telling the recording control unit 14, conveyance control unit 15, and printing control unit 16 to execute the media publication (production) process (S03). Triggered by this publish command, the data conversion unit 20 acquires image data from the editing applications A, B (S04), and generates print data (S05). The content data dragged and dropped into the content data selection area 46 of the print settings window 17 is then acquired from the content data storage unit 12 (S06), and an image file that will be used as the write data by the media processing device 1 is generated (S07). The generated print data and image file are then linked and output to the media processing device 1 (S08). After receiving the print data and image file, the media processing device 1 executes the write process that writes the image file as the write data on the recording surface of the disc D, and executes the printing process based on the print data on the label side of the disc D (S10).

Note that the control device 2 could be configured to issue a publish command upon receiving a signal indicating the OK button 47 was operated in the print settings window 17 instead of using the print button 19 in the print window 18 of the editing application A, B.

The media processing system according to this embodiment of the invention can cause the media processing device 1 to execute the write process and printing process as a continuous operation because the print driver 10 acquires the content data to be written to the disc D, and outputs the generated image file together with the print data to be printed on the label side. Furthermore, because processing is triggered by a print command from the print driver 10, the printing process and the write process can be executed as a continuous process even when printing data created by a common software program on the label side of the media.

Note that a configuration in which the print driver 10 receives an image file previously created from one or more content data sources, links the received image file with print data, and outputs to the media processing device, is also conceivable. In this case the user selects the image file instead of the content data in the print settings window. A configuration in which the main control unit 13 creates an image file from selected content data is also conceivable.

Components of the media processing system SY described above can also be rendered as a program. This program can also be provided stored on a suitable storage medium (not shown in the figure). The storage medium could be, for example, a CD-ROM, flash ROM, memory card (CompactFlash (R), smart media, or memory stick, for example), Compact Disc, magneto-optical disc, DVD, or floppy disk.

The invention is not limited to the foregoing embodiment, and the configuration and process steps of the media processing system SY can be changed in many ways without departing from the scope of the accompanying claims.

What is claimed is:

1. A print data processing method for controlling a media processing device that performs a write process to write data to the recording surface of media based on write data, and a printing process to print on the label side of the media based on print data, comprising:
a production command step that issues a production command for executing a media production process;
an image data acquisition step that acquires image data produced by a desirable application for printing on the label side when triggered by the production command;
a print data generating step that generates print data based on the image data;
a data acquisition step that acquires data used in the write process when triggered by the production command; and
a data output step that links and outputs the print data and the write data to the media processing device.

2. The print data processing method described in claim 1, wherein:
the data acquisition step acquires one or more content data objects;
an image file generating step generates an image file combining the one or more acquired content data objects according to a specific format; and
the data output step outputs the generated image file as the write data.

3. The print data processing method described in claim 1, wherein:
the data acquisition step acquires data used in the write process based on a selection made in a print settings window.

4. The print data processing method described in claim 3, wherein:
the content data is selected from the print settings window.

5. A print driver for controlling a media processing device that performs a write process to write data to the recording surface of media based on write data, and a printing process to print on the label side of the media based on print data, comprising:
an image data acquisition unit that acquires image data produced by a desirable application for printing on the label side;
a print data generating unit that generates print data based on the image data;
a data acquisition unit that acquires data used in the write process; and
an output control unit that links and outputs the print data and the write data to the media processing device.

6. The print driver described in claim 5, wherein:
the data acquisition unit acquires one or more content data objects;
an image file generating unit generates an image file combining the one or more acquired content data objects according to a specific format; and
the output control unit outputs the generated image file as the write data.

7. The print driver described in claim 5, wherein:
the print driver has a function that displays a print settings window; and
the data acquisition unit acquires data used in the write process based on a selection made in the print settings window.

8. The print driver described in claim 7, wherein:
the content data is selected from the print settings window.

9. A control device that comprises the print driver described in claim 5, and is used connected to the media processing device.
